(19) United States
(12) Patent Application Publication
(10) Pub. No.: US 2025/0148980 A1
(43) Pub. Date: May 8, 2025

(54) DISPLAY DEVICE AND DRIVING METHOD FOR THE SAME

(71) Applicant: Sony Semiconductor Solutions Corporation, Kanagawa (JP)

(72) Inventor: Kazuki Yokoyama, Kanagawa (JP)

(21) Appl. No.: 18/838,064

(22) PCT Filed: Mar. 15, 2023
(86) PCT No.: PCT/JP23/10067

§ 371 Date: Aug. 13, 2024

(30) Foreign Application Priority Data
Mar. 25, 2022 (JP) 2022-049409

(51) Int. Cl. G09G 3/3233

(52) U.S. Cl. CPC G09G 3/3233; G09G 2300/0852; G09G 2310/08; G09G 2320/0233

(57) ABSTRACT

Display devices and driving methods are disclosed. In one example, a display device includes pixel groups each including pixels arranged in a first direction are arranged in a second direction intersecting the first direction. A first transistor is provided in each pixel and controls light emission luminance of a light emission element. A first capacitor provided in each pixel is connected between a gate and a source of the first transistor. A display control unit performs first correction processing that simultaneously corrects threshold voltages of the first transistors in the pixel groups, restores a source-gate voltage of the first transistor before the start of the first correction processing, performs second correction processing of sequentially correcting the threshold voltage of the first transistor for each of the pixel groups, and supplies a pixel signal voltage to a gate of the first transistor after the second correction processing.

### TECHNICAL FIELD

The present disclosure relates to a display device and a driving method thereof.

### BACKGROUND ART

A display device using a self light-emitting element such as an organic electro-luminescence (EL) element is known. The light emission luminance is adjusted by controlling the current flowing through the self light-emitting element by a driving transistor.

The threshold voltage of the driving transistor may fluctuate due to manufacturing reasons or the like. When the threshold voltage fluctuates, luminance variation of the screen occurs, and image quality deteriorates. Therefore, in a pixel circuit using a self light-emitting element, it is common to correct a threshold voltage of a driving transistor before causing the self light-emitting element to emit light (see Patent Document 1).

### CITATION LIST

### Patent Document

Patent Document 1: Japanese Patent Application Laid-Open No. 2007-133282

### SUMMARY OF THE INVENTION

### Problems to be Solved by the Invention

In a case where a self light-emitting element is caused to emit light, there is known a driving method in which a threshold voltage of a driving transistor of each pixel is corrected, and then a pixel signal voltage is written in the gate of the driving transistor.

If the threshold voltages of the driving transistors of all the pixels are corrected at the same timing, and then the pixel signal voltage is written for each pixel row, the timing to start writing of the pixel signal voltage is different for each pixel row. Therefore, the correction period of the threshold voltage for each pixel row is also different, and the light emission luminance is different between the upper end side and the lower end side of the display device, and shading may be visually recognized.

Therefore, the present disclosure provides a display device capable of improving display quality and a method for driving the display device.

### Solutions to Problems

In order to solve the above problem, according to the present disclosure, there is provided a display device including:
a pixel array unit in which a plurality of pixel groups each including two or more pixels arranged in a first direction is arranged in a second direction intersecting the first direction;
a light emission element provided in each pixel in the pixel array unit;
a first transistor that is provided in each pixel in the pixel array unit and controls light emission luminance of the light emission element;
a first capacitor provided in each pixel in the pixel array unit and connected between a gate and a source of the first transistor; and
a display control unit that performs first correction processing of simultaneously correcting threshold voltages of the first transistors in a plurality of the pixel groups, then restores a source-gate voltage of the first transistor to a voltage before the start of the first correction processing, and then performs second correction processing of sequentially correcting the threshold voltage of the first transistor for each of the plurality of pixel groups, and supplies a pixel signal voltage to a gate of the first transistor for which the second correction processing has been completed.

Correction of the threshold voltage of the first transistor of each pixel may be completed by the second correction processing.

A length of a period of the first correction processing may be different for each of a plurality of the pixel groups arranged in the second direction, and
a length of the period of the second correction processing may be substantially the same for the plurality of pixel groups.

Immediately before the first correction processing period, the display control unit may temporarily supply an offset voltage to gates of the first transistors in a plurality of the pixel groups to temporarily connect sources to a first reference voltage node, and
during the first correction processing period, the display control unit may cut off the supply of the offset voltage to the gates of the first transistors, and cut off the connection between the sources of the first transistors and the first reference voltage node.

The display control unit may sequentially drive each of the plurality of pixel groups to temporarily connect a source of the first transistor in the pixel group to be driven to a first reference voltage node, and thereafter, during the second correction processing period, the display control unit may cut off the connection between the source of the first transistor and the first reference voltage node and correct a threshold voltage of the first transistor.

The display control unit may cause a source-gate voltage of the first transistor in the pixel group to be driven to match a threshold voltage of the first transistor during the period of the second correction processing.

After the second correction processing of the first transistors in the plurality of pixel groups is completed, the display control unit may simultaneously raise source voltages of the first transistors in the plurality of pixel groups, and cause the light emission elements in the plurality of pixel groups to simultaneously emit light with luminance corresponding to the pixel signal voltage.

The display control unit may start the first correction processing within a vertical blanking period.

The display control unit may sequentially raise a source voltage of the first transistor in the pixel group to be driven for which the second correction processing has been completed, and cause the light emission element in the pixel group to be driven to emit light with luminance corresponding to the pixel signal voltage.

The display control unit may perform the first correction processing within a predetermined period.

The display control unit may simultaneously perform the first correction processing on the first transistors in all the pixel groups in the pixel array unit, and then sequentially perform the second correction processing on the first transistors for each of all the pixel groups.

The plurality of pixel groups arranged in the second direction in the pixel array unit may be divided into two or more pixel blocks, and
the display control unit may perform the first correction processing on the first transistor in the pixel block for each of the two or more pixel blocks, and then sequentially perform the second correction processing on the first transistor for each of the pixel groups in the pixel block.

The display device may include
a second transistor that is provided in each pixel in the pixel array unit and switches whether or not to supply an offset voltage or the pixel signal voltage to a gate of the first transistor, and
a third transistor that is provided in each pixel in the pixel array unit and switches whether or not to connect a source of the first transistor to a predetermined first reference voltage node.

The display control unit may
temporarily turn on the second transistors in a plurality of the pixel groups to temporarily supply an offset voltage to gates of the first transistors and temporarily turn on the third transistors in the plurality of pixel groups to temporarily connect sources of the first transistors to the first reference voltage node to simultaneously correct threshold voltages of the first transistors in the plurality of pixel groups arranged in the second direction during the period of the first correction processing,
thereafter sequentially drive each of the plurality of pixel groups to temporarily turn on the third transistor in the pixel group to be driven and temporarily connect the source of the first transistor to the first reference voltage node,
during the period of the second correction processing, cut off the connection between the source of the first transistor and the first reference voltage node to correct the threshold voltage of the first transistor, and
thereafter, temporarily turn on the second transistor connected to the gate of the first transistor whose threshold voltage has been corrected, and supply the pixel signal voltage to the gate of the first transistor whose threshold voltage has been corrected.

Immediately before the second correction processing period, the display control unit may repeat an operation of temporarily turning on the third transistor in the pixel group to be driven a plurality of times, and thereafter, turn off the second transistor and the third transistor to correct the threshold voltage of the first transistor.

The display device may include
a fourth transistor that switches whether or not to connect a drain of the first transistor to a second reference voltage node, and
a second capacitor connected between a source of the first transistor and a source of the third transistor.

The light emission element may be connected between a drain of the first transistor and the second reference voltage node.

Before the second transistor transitions from off to on in a state where the pixel signal voltage is supplied to a source of the second transistor, the fourth transistor may maintain an on state, and a drain of the first transistor may be connected to the second reference voltage node, and
when the second transistor transitions from off to on in a state where the pixel signal voltage is supplied to the source of the second transistor, the fourth transistor may be turned off, and then the third transistor may be turned on, and light emission of the light emission element may be started.

The first transistor, the second transistor, the third transistor, and the fourth transistor may include P-type metal oxide semiconductor (MOS) transistors.

While the threshold voltage of the first transistor is corrected in one of the two pixel groups in the second direction, the display control unit may supply the pixel signal voltage to a gate of the first transistor in the other of the two pixel groups.

The light emission element may include an organic electro-luminescence (EL) element.

According to the present disclosure, there is provided a driving method of a display device including:
a pixel array unit in which a plurality of pixel groups each including two or more pixels arranged in a first direction is arranged in a second direction intersecting the first direction;
a light emission element provided in each pixel in the pixel array unit;
a first transistor that is provided in each pixel in the pixel array unit and controls light emission luminance of the light emission element; and
a first capacitor provided in each pixel in the pixel array unit and connected between a gate and a source of the first transistor, the method including
performing first correction processing of simultaneously correcting threshold voltages of the first transistors in a plurality of the pixel groups, then restoring a source-gate voltage of the first transistor to a voltage before the start of the first correction processing, and then performing second correction processing of sequentially correcting the threshold voltage of the first transistor for each of the plurality of pixel groups, and supplying a pixel signal voltage to a gate of the first transistor for which the second correction processing has been completed.

### BRIEF DESCRIPTION OF DRAWINGS

FIG. 1 is a block diagram illustrating a schematic configuration of a display device.

FIG. 2 is a block diagram illustrating a detailed configuration of a display unit.

FIG. 3 is a diagram illustrating a circuit configuration of each pixel in a pixel array unit.

FIG. 4A is a diagram for describing a line sequential driving method.

FIG. 4B is a diagram for describing a surface collective driving method.

FIG. 5 is a drive timing diagram according to a comparative example in a case where the surface collective driving method of FIG. 4B is adopted.

FIG. 6 is a diagram illustrating a source voltage waveform and a gate voltage waveform of the driving transistor of FIG. 5.

FIG. 7A is a diagram illustrating a source voltage waveform and a gate voltage waveform of a driving transistor in a case where a Vth correction period is too short.

FIG. 7B is a diagram illustrating a source voltage waveform and a gate voltage waveform of the driving transistor in a case where the Vth correction period is too long.

FIG. 8 is a diagram for describing a fluctuation amount of a gate voltage and a fluctuation amount of a source voltage of a driving transistor at the time of the Vth correction.

FIG. 9 is a diagram illustrating a current flowing through a pixel at the time of the Vth correction.

FIG. 10 is a circuit diagram of a pixel according to an embodiment.

FIG. 11 is a view illustrating a source voltage waveform and a gate voltage waveform of a driving transistor in the circuit of FIG. 10.

FIG. 12 is a diagram illustrating a current flowing through the pixel in FIGS. 8 and 11.

FIG. 13 is a diagram schematically illustrating a scanning order of a display device 1 according to the present embodiment.

FIG. 14A is a timing diagram of the display device 1 according to an embodiment.

FIG. 14B is a timing diagram of a display device 1 according to a comparative example.

FIG. 15 is a timing diagram according to a modification of FIG. 14A.

FIG. 16A is a diagram illustrating an internal state of a vehicle from the rear side to the front side of the vehicle.

FIG. 16B is a diagram illustrating an internal state of the vehicle from an oblique rear side to an oblique front side of the vehicle.

FIG. 17A is a front view of a digital camera as a second application example of an electronic device.

FIG. 17B is a rear view of the digital camera.

FIG. 18A is an external view of an HMD as a third application example of the electronic device.

FIG. 18B is an external view of smart glasses.

FIG. 19 is an external view of a TV as a fourth application example of the electronic device.

FIG. 20 is an external view of a smartphone as a fifth application example of the electronic device.

### MODE FOR CARRYING OUT THE INVENTION

Hereinafter, embodiments of a display device and a driving method thereof will be described with reference to the drawings. Although main components of the display device will be mainly described below, the display device may have a component or function that is not illustrated or described. The following description does not exclude components and functions that are not illustrated or described.

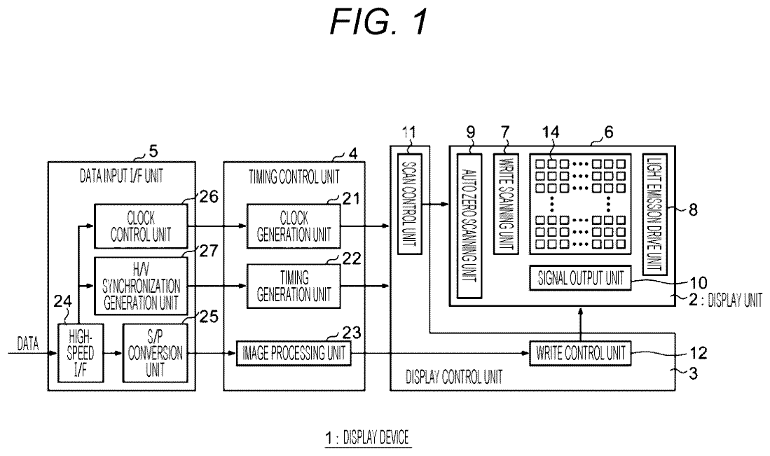

FIG. 1 is a block diagram illustrating a schematic configuration of a display device 1. The display device 1 of FIG. 1 is a display device 1 using a self light-emitting element such as an organic light emitting device (OLED), and one implementation form is a microdisplay. Note that the display device 1 of FIG. 1 is not limited to a microdisplay, and can be incorporated in various electronic devices and applied as a display unit of any size and display resolution.

The display device 1 of FIG. 1 includes a display unit 2, a display control unit 3, a timing control unit 4, and a data input/output I/F unit 5.

The display unit 2 includes a pixel array unit 6, a write scanning unit 7, a light emission drive unit 8, an auto zero scanning unit 9, and a signal output unit 10. The internal configuration and operation of the display unit 2 will be described later.

The display control unit 3 includes a scan control unit 11 and a write control unit 12. The scan control unit 11 determines a scan timing of each pixel row in the pixel array unit 6 and controls the write scanning unit 7. The write control unit 12 determines the light emission luminance of each pixel 14 in the pixel array unit 6 and controls the signal output unit 10.

The timing control unit 4 includes a clock generation unit 21, a timing generation unit 22, and an image processing unit 23. The clock generation unit 21 generates a clock signal corresponding to the drive timing of each pixel row in the pixel array unit 6, a clock signal corresponding to the timing at which the pixel signal voltage is written to each pixel 14 of each pixel row in the pixel array unit 6, and the like. The timing generation unit 22 generates a signal (for example, horizontal synchronization signal, vertical synchronization signal, or the like) for controlling the timing of the display control unit 3. The image processing unit 23 generates a pixel signal corresponding to the light emission luminance of the self light-emitting element in each pixel 14 of the display unit 2.

The data input/output I/F unit 5 includes a high-speed I/F unit 24, an S/P conversion unit 25, a clock control unit 26, and an H/V synchronization generation unit 27. The high-speed I/F unit 24 receives image data, a clock signal, and the like from a host device (not illustrated) at high speed. The S/P conversion unit 25 converts the parallel image data received by the high-speed I/F unit 24 into serial image data and supplies the serial image data to the image processing unit 23. The clock control unit 26 extracts a clock signal from the data received by the high-speed I/F unit 24 and supplies the clock signal to the clock generation unit 21. The H/V synchronization generation unit 27 extracts a horizontal synchronization signal and a vertical synchronization signal from the data received by the high-speed I/F unit 24 and supplies the signals to the timing generation unit 22.

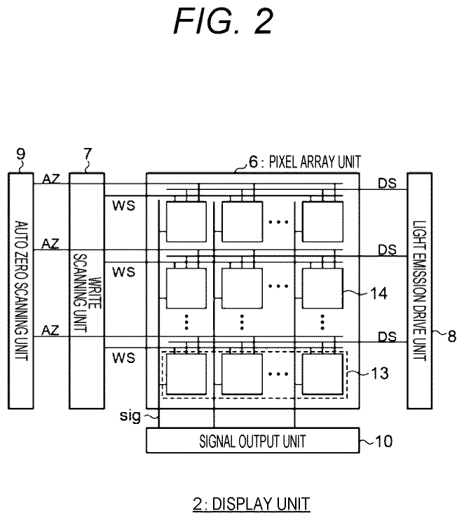

FIG. 2 is a block diagram illustrating a detailed configuration of the display unit 2. In the pixel array unit 6, a plurality of pixels 14 is arranged in a horizontal direction (first direction) and a vertical direction (second direction). In the present specification, the horizontal direction is referred to as a row, the vertical direction is referred to as a column, and the plurality of pixels 14 arranged in the horizontal direction is referred to as a pixel row 13 or a pixel group. In the pixel array unit 6, a plurality of pixel rows 13 extending in the horizontal direction is arranged in the vertical direction. The number of pixels 14 in the pixel array unit 6 in the horizontal direction and the vertical direction is arbitrary. A detailed configuration of the pixel 14 will be described later.

The write scanning unit 7 drives a plurality of write scanning lines. The plurality of write scanning lines is provided for each pixel row 13. Each write scanning line extends in the horizontal direction and supplies a write scanning signal to each pixel 14 in the corresponding pixel row 13.

The light emission drive unit 8 drives a plurality of light emission control lines. The plurality of light emission control lines is provided for each pixel row 13. Each light emission control line in the horizontal direction and supplies a light emission control signal to each pixel 14 in the corresponding pixel row 13.

The auto zero scanning unit 9 drives a plurality of auto zero signal lines (hereinafter referred to as AZ signal line). The plurality of AZ signal lines extends in the horizontal direction and supplies an AZ signal to each pixel 14 in the corresponding pixel row 13. The AZ signal is used to stop light emission of the light emission element until the threshold voltage correction of the driving transistor in each pixel 14 is completed.

The signal output unit 10 drives a plurality of data lines sig. The plurality of data lines sig extends in the vertical direction and supplies an offset voltage or a pixel signal voltage to the corresponding pixel 14. As described above, the data line sig is used to supply the offset voltage or the pixel signal voltage at different timings.

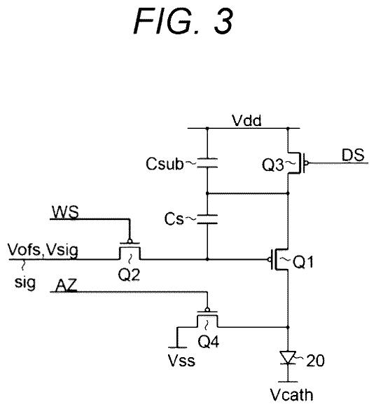

FIG. 3 is a diagram illustrating a circuit configuration of each pixel 14 in the pixel array unit 6. Each pixel 14 includes four PMOS transistors Q1 to Q4 and two capacitors Cs and Csub, and may be referred to as Pch 4Tr2C. Hereinafter, the four transistors in each pixel 14 are referred to as a driving transistor (first transistor) Q1, a WS transistor (second transistor) Q2, a DS transistor (third transistor) Q3, and an AZ transistor (fourth transistor) Q4. Furthermore, hereinafter, the two capacitors Cs and Csub in each pixel 14 are referred to as a first capacitor Cs and a second capacitor Csub.

Furthermore, hereinafter, an example in which a self light-emitting element including an OLED 20 is arranged in each pixel 14 will be described.

The AZ transistor Q4 is connected between the drain of the driving transistor Q1 and a second reference voltage node Vss. More specifically, the source of the AZ transistor Q4 is connected to the drain of the driving transistor Q1, and the drain of the AZ transistor Q4 is connected to the second reference voltage node Vss.

The OLED 20 is connected between the drain of the driving transistor Q1 and a third reference voltage node Vcath. More specifically, the anode of the OLED 20 is connected to the drain of the driving transistor Q1, and the cathode of the OLED 20 is connected to the third reference voltage node Vcath. The voltage level of the third reference voltage node Vcath may be the same as or different from the voltage level of the second reference voltage node Vss.

The WS transistor Q2 is connected between the gate of the driving transistor Q1 and the data line sig. More specifically, the drain of the WS transistor Q2 is connected to the gate of the driving transistor Q1, and the source of the WS transistor Q2 is connected to the data line sig. A WS signal is input to the gate of the WS transistor Q2.

The DS transistor Q3 is connected between the source of the driving transistor Q1 and a power supply potential node (first reference voltage node) Vdd. More specifically, the source of the driving transistor Q1 is connected to the drain of the DS transistor Q3. The source of the DS transistor Q3 is connected to the power supply potential node Vdd.

The first capacitor Cs is connected between the gate and the source of the driving transistor Q1. The second capacitor Csub is connected between the source and the drain of the DS transistor Q3. That is, the first capacitor Cs and the second capacitor Csub are connected in series between the power supply potential node Vdd and the gate of the driving transistor Q1.

As a method of driving the pixels of the display device 1, there are a line sequential driving method of sequentially driving the pixels in each pixel row 13 and a surface collective driving method of collectively driving all the pixels 14 in all the pixel rows 13. The line sequential driving method is also called a progressive driving method. The display device 1 according to one embodiment can be applied to both the line sequential driving method and the surface collective driving method. Furthermore, the pixel array unit 6 may be divided into a plurality of pixel blocks in the vertical direction, and each pixel 14 may be driven by the line sequential driving method or the surface collective driving method for each pixel block.

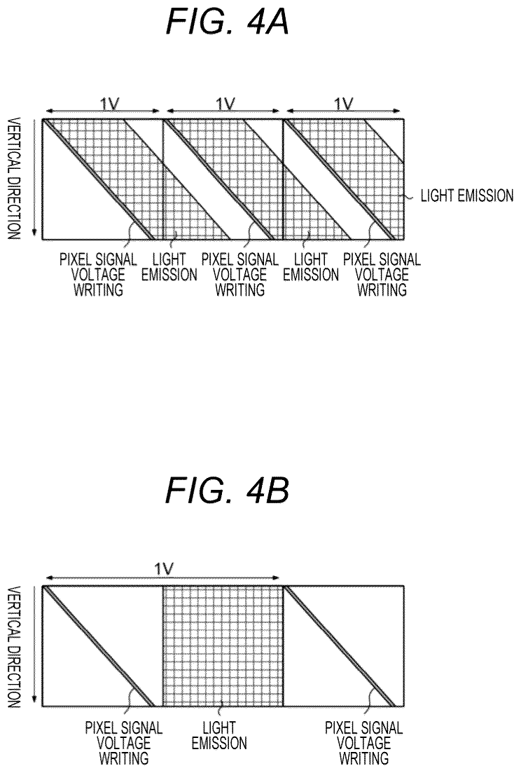

FIG. 4A is a diagram for describing the line sequential driving method, and FIG. 4B is a diagram for describing the surface collective driving method. In the line sequential driving method of FIG. 4A, light emission of the OLED 20 is started immediately after writing the pixel signal voltage of each pixel row 13. That is, the light emission timing is shifted for each pixel row 13. On the other hand, in the surface collective driving method of FIG. 4B, the light emission of all the pixel rows 13 is collectively performed after the writing of the pixel signal voltages of all the pixel rows 13 is completed.

### One Comparative Example

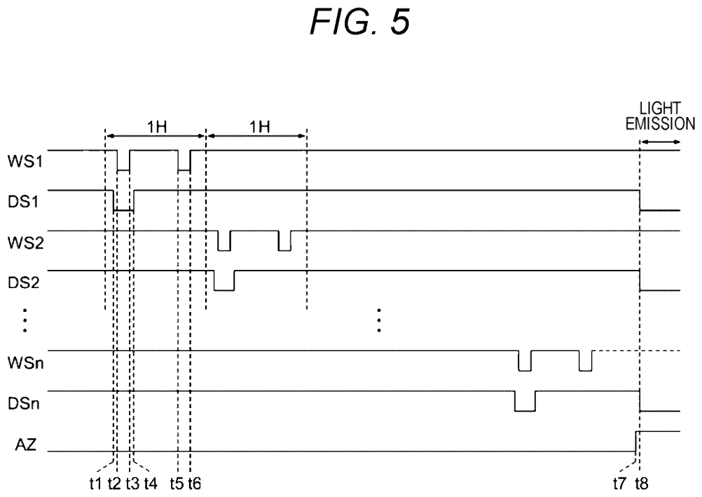

FIG. 5 is a drive timing diagram according to a comparative example in a case where the surface collective driving method of FIG. 4B is adopted. Hereinafter, the operation of the circuit of the pixel 14 in FIG. 3 will be described with reference to the timing diagram of FIG. 5. Note, however, that in the following description, depending on the pixel signal voltage to be written, the direction of some voltage fluctuations may be reversed from that in the following description.

In the pixel 14 of FIG. 3, the threshold voltage of the driving transistor Q1 is corrected before the pixel signal voltage is supplied to the data line sig. In correcting the threshold voltage of the driving transistor Q1, first, the DS transistor Q3 of the first pixel row 13 is turned on (time t1). As a result, the accumulated charge of the second capacitor Csub is discharged and reset. Note that the AZ transistor Q4 is continuously set to the on state until light emission of the OLED 20 is started.

Next, while the DS transistor Q3 of the first pixel row 13 is kept turned on, an offset voltage Vofs is supplied to the data line sig, and the WS transistor Q2 is turned on (time t2). As a result, the offset voltage Vofs is supplied to the gate of the driving transistor Q1 via the WS transistor Q2. At this time, since the DS transistor Q3 is turned on, the source of the driving transistor Q1 becomes the power supply potential Vdd.

Thereafter, the WS transistor Q2 is turned off (time t3), and subsequently, the DS transistor Q3 is turned off (time t4). As a result, the source voltage of the driving transistor Q1 starts to decrease. Since the first capacitor Cs is connected between the gate and the source of the driving transistor Q1, when the source voltage of the driving transistor Q1 decreases, the gate voltage of the driving transistor Q1 also decreases in conjunction therewith. When the gate-source voltage of the driving transistor Q1 eventually matches the threshold voltage of the driving transistor Q1, the gate voltage and the source voltage of the driving transistor Q1 are stabilized, and the threshold voltage correction processing ends.

Thereafter, a pixel signal voltage Vsig is supplied to the data line sig, and the WS transistor Q2 of each pixel 14 of the pixel row 13 for which the threshold voltage correction processing has been completed is temporarily turned on (times t5 to t6). As a result, a voltage corresponding to the pixel signal voltage Vsig and the threshold voltage is supplied to the gate of the driving transistor Q1 to be driven, and writing of the pixel signal voltage Vsig is performed.

The above operation is sequentially performed for each pixel row 13, and writing of the pixel signal voltage Vsig is sequentially performed line by line.

When the writing of the pixel signal voltage Vsig to all the pixel rows 13 is completed and the light emission timing of the OLED 20 is reached, the AZ transistors Q4 of all the pixels 14 are turned off (time t7), and the DS transistor Q3 is turned on (time t8). As a result, a current corresponding to the pixel signal voltage Vsig flows from the driving transistor Q1 to the OLED 20, and light is emitted with light emission luminance corresponding to the pixel signal voltage Vsig.

As described above, in the display device 1 according to the comparative example illustrated in FIG. 5, the threshold voltage of the driving transistor Q1 of each pixel 14 is corrected for each pixel row 13, and then the pixel signal voltage Vsig is written to each pixel 14.

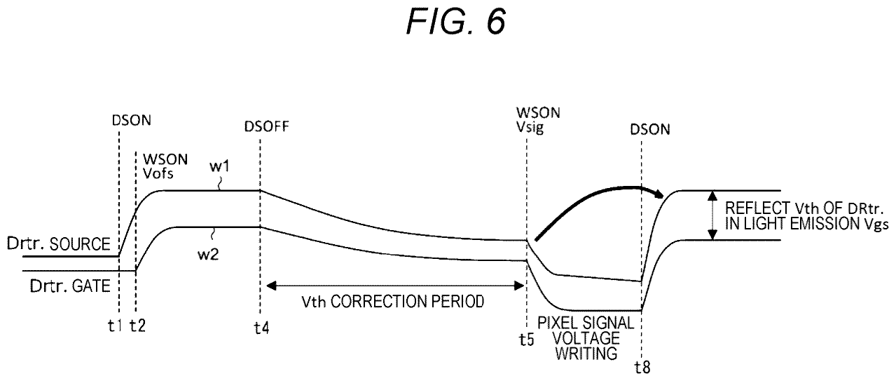

FIG. 6 is a diagram illustrating a source voltage waveform w1 and a gate voltage waveform w2 of the driving transistor Q1 at times t1 to t8 in FIG. 5. When the DS transistor Q3 is turned on at time t1, the source voltage of the driving transistor Q1 starts to rise. Thereafter, the WS transistor Q2 is turned on at time t2, and the gate voltage of the driving transistor Q1 starts to rise due to the offset voltage Vofs on the data line sig. Note that depending on the voltage level of the offset voltage Vofs, the gate voltage of the driving transistor Q1 may start to decrease.

After a while from time t2, the voltage levels of the source voltage and the gate voltage of the driving transistor Q1 are stabilized. The potential difference between the source voltage and the gate voltage is (Vdd-Vofs).

When the WS transistor Q2 is turned off at time t3 and then the DS transistor Q3 is turned off at time t4, the source voltage of the driving transistor Q1 starts to decrease, and accordingly, the gate voltage of the driving transistor Q1 also starts to decrease. The potential difference between the source voltage and the gate voltage of the driving transistor Q1 is stabilized in a state of matching with the threshold voltage of the driving transistor Q1.

When the WS transistor Q2 is turned on at time t5, the gate voltage of the driving transistor Q1 starts to decrease by the pixel signal voltage Vsig on the data line sig. Accordingly, the source voltage of the driving transistor Q1 also starts to decrease. Note that depending on the voltage level of the pixel signal voltage Vsig, the gate voltage of the driving transistor Q1 may start to increase, and the source voltage of the driving transistor Q1 may start to decrease.

Thereafter, when the DS transistor Q3 is turned on at time t8, the source voltage of the driving transistor Q1 increases, and accordingly, the gate voltage of the driving transistor Q1 also increases, and the potential difference between the source voltage and the gate voltage of the driving transistor Q1 becomes a value corresponding to the pixel signal voltage Vsig. As a result, a current flows from the DS transistor Q3 to the OLED 20 via the driving transistor Q1, and the OLED 20 emits light with light emission luminance corresponding to the pixel signal voltage Vsig. Note that as described above, the source voltage and the gate voltage of the driving transistor Q1 may decrease at time t8.

Time t4 to t5 in FIG. 6 is a correction period of the threshold voltage of the driving transistor Q1, and is also referred to as a Vth correction period. The period from time t4 to time t5 needs to be set to such a time length that the source-gate voltages of all the driving transistors Q1 to be corrected become threshold voltages.

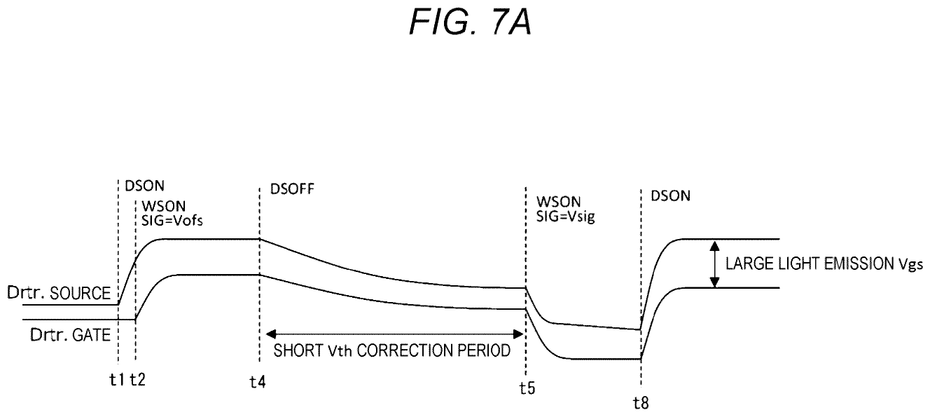

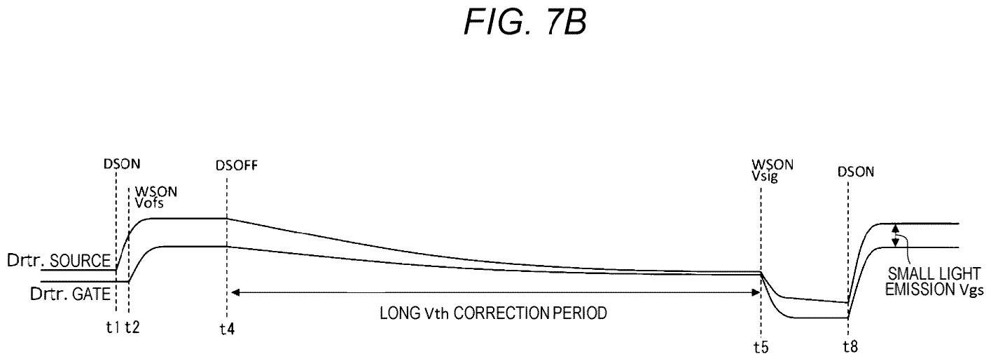

FIG. 7A is a diagram illustrating a source voltage waveform w1 and a gate voltage waveform w2 of the driving transistor Q1 in a case where the Vth correction period is relatively short. FIG. 7B is a diagram illustrating the source voltage waveform w1 and the gate voltage waveform w2 of the driving transistor Q1 in a case where the Vth correction period is relatively long.

In a case where the Vth correction period is relatively short as in FIG. 7A, the source-gate voltage of the driving transistor Q1 becomes larger than the threshold voltage. Conversely, in a case where the Vth correction period is relatively long as in FIG. 7B, the accumulated charge of the first capacitor Cs is gradually discharged, the source-gate voltage of the driving transistor Q1 becomes smaller than the threshold voltage, and finally, the source voltage and the gate voltage become substantially equal.

As described above, the source-gate voltage of the driving transistor Q1 changes between a case where the Vth correction period is relatively short and a case where the Vth correction period is relatively long. As the source-gate voltage of the driving transistor Q1 increases, the current flowing through the OLED 20 during light emission increases as illustrated in FIG. 7A, and the light emission luminance increases.

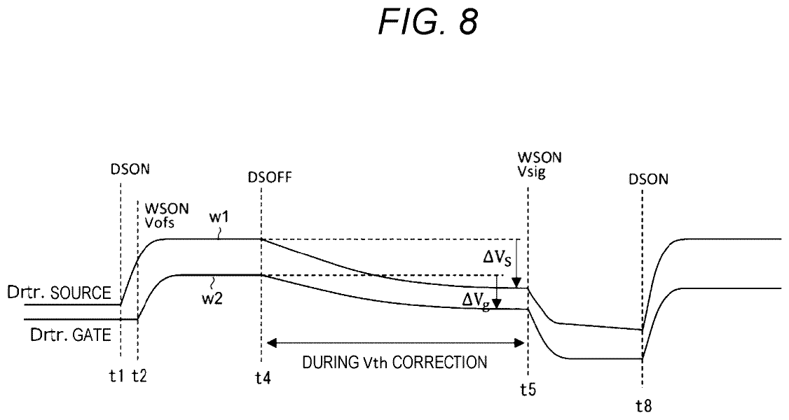

FIG. 8 is a diagram for describing a fluctuation ΔVg of the gate voltage and a fluctuation Vs of the source voltage of the driving transistor Q1 at the time of the Vth correction. ΔVg and ΔVs satisfy the following formula (1). Note that α is a proportionality constant.

$$Δ Vg = α Δ Vs \qquad ( 1 )$$

The proportionality constant & in formula (1) is expressed by the following formula (2).

$$α = Cgs / Cgg \qquad ( 2 )$$

Cgg in formula (2) is the total capacitance of the gate of the driving transistor Q1, and Cgs in formula (2) is the coupling capacitance between the source and the gate of the driving transistor Q1.

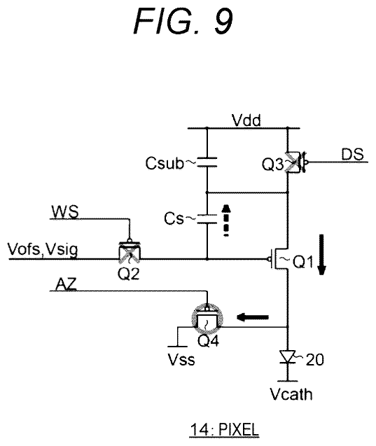

FIG. 9 is a diagram illustrating a current flowing through the pixel 14 at the time of the Vth correction. As illustrated in FIG. 9, at the time of the Vth correction, both the WS transistor Q2 and the DS transistor Q3 are off, and the AZ transistor Q4 is on. As a result, the accumulated charge of the first capacitor Cs is discharged between the source and the drain of the driving transistor Q1. The current flowing between the source and the drain of the driving transistor Q1 flows through the AZ transistor Q4. Therefore, the source voltage and the gate voltage of the driving transistor Q1 gradually decrease. The degree of change in the source voltage and the degree of change in the gate voltage are in a linear relationship as shown in formula (1). The proportionality constant α, which is the slope of the degree of change in the source voltage with respect to the degree of change in the gate voltage, depends on the coupling capacitance between the source and the gate with respect to the total capacitance of the driving transistor Q1, as shown in formula (2), and 0<α<1.

During the Vth correction period, both the source voltage and the gate voltage of the driving transistor Q1 gradually decrease. However, since the proportionality constant α in formula (2) is a value less than 1, the degree of decrease of the source voltage becomes larger than that of the gate voltage, and the voltage between the source and the gate of the driving transistor Q1 gradually decreases.

As described above, the voltage between the source and the gate of the driving transistor Q1 changes depending on the length of the Vth correction period, and thereafter, even when the pixel signal voltage Vsig is applied to the gate voltage of the driving transistor Q1, a difference occurs in the voltage between the source and the gate of the driving transistor Q1. When the voltage between the source and the gate of the driving transistor Q1 fluctuates, the light emission luminance of the OLED 20 is affected. Therefore, control is required such that the voltage between the source and the gate of the driving transistor Q1 does not fluctuate due to the length of the Vth correction period. In the display device 1 according to the embodiment described below, the voltage between the source and the gate of the driving transistor Q1 is made constant regardless of the length of the Vth correction period.

### One Embodiment

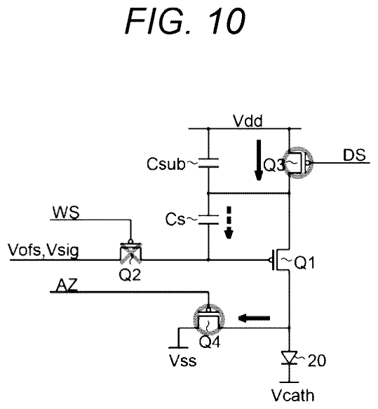

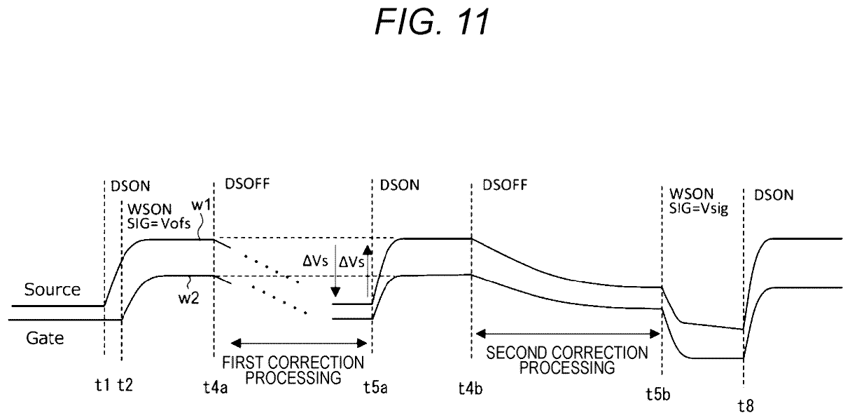

FIG. 10 is a circuit diagram of a pixel 14 according to an embodiment, and FIG. 11 is a diagram illustrating a source voltage waveform w1 and a gate voltage waveform w2 of a driving transistor Q1 of the circuit of FIG. 10. The circuit of FIG. 10 has the same circuit configuration as the circuit of FIG. 3, but the current flowing in the circuit at the time of Vth correction is different from that in FIG. 9.

In a pixel 14 according to the embodiment, as illustrated in FIG. 11, the Vth correction period is divided into two periods, and hereinafter, are referred to as a first correction processing period in which first correction processing is performed and a second correction processing period in which second correction processing is performed. The second correction processing is performed after the first correction processing. The correction of the threshold voltage of the driving transistor Q1 of each pixel 14 is completed by the second correction processing. FIG. 10 illustrates a current flowing in the pixel 14 immediately before the start of the second correction processing.

The length of the first correction processing period is different for each of the plurality of pixel rows 13 arranged in the second direction. The length of the second correction processing period is substantially the same in the plurality of pixel rows 13.

After performing the first correction processing of simultaneously correcting the threshold voltages of the driving transistors Q1 in the plurality of pixel rows 13, the display control unit 3 restores the source-gate voltage of the driving transistor Q1 to the voltage before the start of the first correction processing, and thereafter, performs the second correction processing of sequentially correcting the threshold voltage of the driving transistor Q1 for each of the plurality of pixel rows 13, and supplies the pixel signal voltage Vsig to the gate of the driving transistor Q1 after the second correction processing.

Immediately before the first correction processing period, the display control unit 3 temporarily supplies the offset voltage Vofs to the gates of the driving transistors Q1 in the plurality of pixel rows 13 to temporarily connect the sources to a first reference voltage node Vdd, and during the first correction processing period, the display control unit 3 cuts off the supply of the offset voltage Vofs to the gates of the driving transistors Q1, and cuts off the connection between the sources of the driving transistors Q1 and the first reference voltage node Vdd.

In a case where the progressive drive method is adopted, the display control unit 3 sequentially drives each of the plurality of pixel rows 13 to temporarily connect the source of the driving transistor Q1 in the pixel row 13 to be driven to the first reference voltage node Vdd, and thereafter, in the second correction processing period, the connection between the source of the driving transistor Q1 and the first reference voltage node Vdd is cut off to correct the threshold voltage of the driving transistor Q1.

During the second correction processing period, the display control unit 3 matches the source-gate voltage of the driving transistor Q1 in the pixel row 13 to be driven with the threshold voltage of the driving transistor Q1.

After completion of the second correction processing of the driving transistors Q1 in the plurality of pixel rows 13, the display control unit 3 simultaneously raises the source voltages of the driving transistors Q1 in the plurality of pixel rows 13, and causes the light emission elements in the plurality of pixel rows 13 to simultaneously emit light with luminance corresponding to the pixel signal voltage Vsig.

The display control unit 3 sequentially raises the source voltage of the driving transistor Q1 in the driving target pixel row 13 for which the second correction processing has been completed, and causes the light emission element in the driving target pixel row 13 to emit light with luminance corresponding to the pixel signal voltage Vsig. The display control unit 3 may perform the first correction processing within a predetermined period.

The display control unit 3 may simultaneously perform the first correction processing on the driving transistors Q1 in all the pixel rows 13 in the pixel array unit 6, and then sequentially perform the second correction processing on the driving transistors Q1 for each of all the pixel rows 13.

Alternatively, the display control unit 3 may divide the plurality of pixel rows 13 arranged in the second direction in the pixel array unit 6 into two or more pixel blocks. In this case, the display control unit 3 may perform the first correction processing on the driving transistor Q1 in the pixel block for each of the two or more pixel blocks, and then sequentially perform the second correction processing on the driving transistor Q1 for each pixel row 13 in the pixel block.

In the case of collectively controlling the display of all the pixels 14 in the pixel array unit 6, the threshold voltage of the driving transistor Q1 in all the pixels 14 is simultaneously corrected in the first correction processing. In performing the first correction processing, the DS transistor Q3 is turned on at time t1 in FIG. 11. As a result, the source voltage of the driving transistor Q1 gradually increases and eventually reaches a power supply voltage Vdd. As described above, the source voltage of the driving transistor Q1 may gradually decrease.

In addition, the WS transistor Q2 is temporarily turned on at time t2. At time t2, the offset voltage Vofs is supplied onto the data line sig. As a result, the gate voltage of the driving transistor Q1 gradually increases. As described above, the gate voltage of the driving transistor Q1 may gradually decrease.

At time t4a, the DS transistor Q3 is turned off. As a result, both the source voltage and the gate voltage of the driving transistor Q1 start to decrease. The source voltage and the gate voltage of the driving transistor Q1 gradually decrease with time according to the formulae (1) and (2) described above.

Thereafter, the DS transistor Q3 is turned on at time t5a. The operation from time t1 to time t5a is the same as the operation from time t1 to time t5 in FIG. 8. Turning on the DS transistor Q3 at time t5a is an operation not assumed in FIGS. 8 and 9. When the DS transistor Q3 is turned on, as illustrated in FIG. 11, the source voltage of the driving transistor Q1 rapidly increases, and accordingly, the gate voltage of the driving transistor Q1 also rapidly increases, and the voltage between the source and the gate of the driving transistor Q1 becomes the same as the voltage between the source and the gate of the driving transistor Q1 at the time point (time t4a) when the first correction processing is started.

FIG. 10 illustrates a state at time t5a. At time t5a, the DS transistor Q3 and the AZ transistor Q4 are turned on, and the WS transistor Q2 is turned off. The current flowing between the source and the drain of the DS transistor Q3 flows to the second reference voltage node Vss between the source and the drain of the AZ transistor Q4, and does not flow to the OLED 20. Therefore, the OLED 20 does not emit light. In addition, a part of the current flowing between the source and the drain of the DS transistor Q3 also flows to the first capacitor Cs, and the voltage between both ends of the first capacitor Cs, that is, the voltage between the Source and the gate of the driving transistor Q1 becomes substantially equal to the potential difference at time point t4a at which the first correction processing is started.

Assuming that the decrease in the source voltage of the driving transistor Q1 within the first correction processing period is ΔVs and the decrease in the gate voltage is ΔVg, the following formula (3) is established by turning on the DS transistor Q3 at time t5a, and the gate voltage is restored to the voltage immediately before the start of the first correction processing.

$$Δ Vg = α ( Δ Vs + ( - Δ Vs ) ) = 0 \qquad ( 3 )$$

As described above, the voltage between the source and the gate of the driving transistor Q1 at the end of the first correction processing period changes depending on the length of the first correction processing period. However, by turning on the DS transistor Q3 after the end of the first correction processing period, the voltage between the source and the gate of the driving transistor Q1 can be restored to the voltage immediately before the start of the first correction processing.

Thereafter, at time t4b, the DS transistor Q3 is turned off to start the second correction processing. During the second correction processing period, similarly to the first correction processing period, since the WS transistor Q2 and the DS transistor Q3 are turned off, both the source voltage and the gate voltage of the driving transistor Q1 gradually decrease, and the voltage between the source and the gate of the driving transistor Q1 also gradually decreases.

The period of the second correction processing (time t4b to t5b) is controlled to have an appropriate time length. Specifically, the period of the second correction processing is set in advance to a time length such that the voltage between the source and the gate of the driving transistor Q1 substantially matches the threshold voltage of the driving transistor Q1.

When the WS transistor Q2 is turned on at time t5b, the second correction processing ends. At time t5b, the pixel signal voltage Vsig is supplied onto the data line sig. Therefore, the gate voltage of the driving transistor Q1 decreases according to the voltage level of the pixel signal voltage Vsig, and the source voltage of the driving transistor Q1 also changes with the change in the gate voltage.

Thereafter, when the DS transistor Q3 is turned on at time t8, the source voltage of the driving transistor Q1 increases, and accordingly, the gate voltage also increases. The voltage between the source and the gate of the driving transistor Q1 is a value dependent on the pixel signal voltage Vsig, and the OLED 20 starts light emission with light emission luminance corresponding to the pixel signal voltage Vsig.

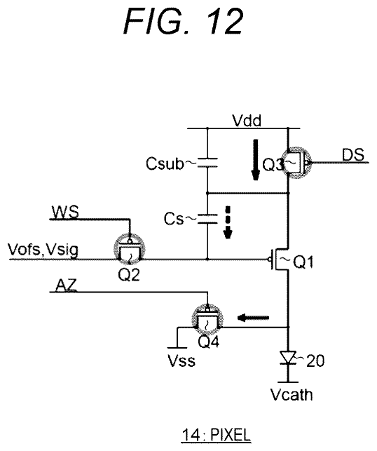

FIG. 12 is a diagram illustrating a current flowing through the pixel 14 at time t2 in FIGS. 8 and 11. At time t2, all of the WS transistor Q2, the DS transistor Q3, and the AZ transistor Q4 are turned on, and the offset voltage Vofs is supplied to the data line sig. On the other hand, at time t5a in FIG. 11, as illustrated in FIG. 10, both the DS transistor Q3 and the AZ transistor Q4 are turned on, but the WS transistor Q2 is turned off. Therefore, no voltage of the data line sig affects the source voltage and the gate voltage of the driving transistor Q1.

The individual data lines sig extend in the vertical direction in the pixel array unit 6 and are connected to the pixels 14 in the same column in different pixel rows 13. Therefore, at time t5a, when the voltage between the source and the gate of the driving transistor Q1 of the corresponding pixel 14 in a certain pixel row 13 is restored to the potential difference immediately before the start of the first correction processing, the WS transistor Q2 can be turned on to write the pixel signal to the corresponding pixel 14 in another pixel row 13 to which the same data line sig is connected.

As described above, in the display device 1 according to the present embodiment, while the threshold voltage of the driving transistor Q1 is corrected in one of the two pixel rows 13, the pixel signal voltage Vsig can be written to the driving transistor Q1 in the other pixel row 13, and parallel processing can be performed. Therefore, drawing for one frame can be performed at high speed.

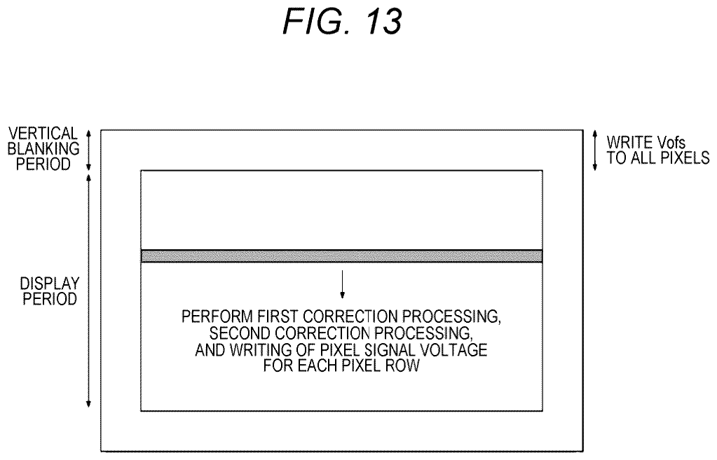

FIG. 13 is a diagram schematically illustrating a scanning order of the display device 1 according to the present embodiment. FIG. 13 illustrates an example of adopting the surface collective driving method. In the display device 1 according to the present embodiment, the offset voltage Vofs is collectively written to all the pixels 14 in all the pixel rows 13 in a vertical blanking period, and the first correction processing is performed.

Next, for example, the second correction processing is sequentially performed for each pixel row 13 from the pixel row 13 on the upper end side, the threshold voltage of each pixel 14 in the pixel row 13 to be driven is corrected, and then the pixel signal voltage Vsig is written. When the second correction processing up to the pixel row 13 at the lower end is completed, light emission of all pixels 14 in all pixel rows 13 is started.

Note that in a case where the progressive driving method is adopted, the timing at which the offset voltage Vofs is collectively written to all the pixels 14 in all the pixel rows 13 is not necessarily the vertical blanking period.

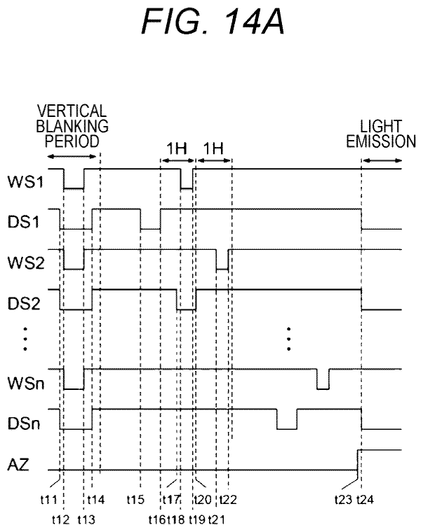

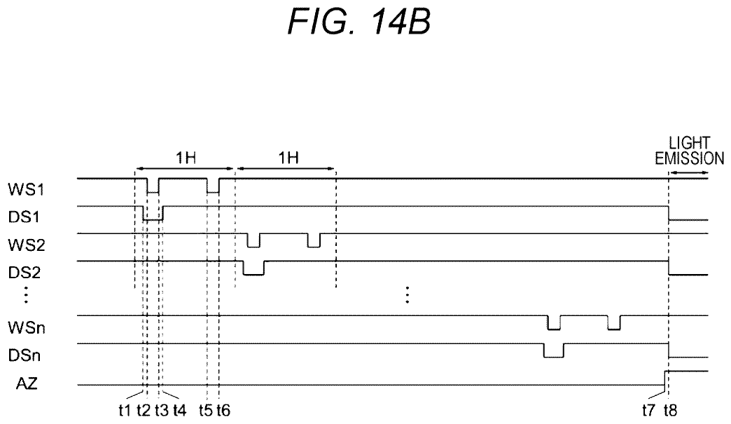

FIG. 14A is a timing diagram of the display device 1 according to an embodiment. In addition, FIG. 14B is a timing diagram of a display device 1 according to a comparative example. The timing diagram of FIG. 14B is substantially the same as that of FIG. 5.

In the display device 1 according to the embodiment, for example, within the vertical blanking period, the WS transistors Q2 and the DS transistors Q3 of all the pixels 14 in the pixel array unit 6 are both turned on (times t12 to t13), and the first correction processing is performed (times t11 to t15).

As described above, in the present embodiment, since the operation of turning on both the WS transistor Q2 and the DS transistor Q3 is performed in the vertical blanking period, it is not necessary to turn on both the WS transistor Q2 and the DS transistor Q3 in one horizontal line period, so that there is plenty of time to perform the pixel signal writing of each pixel 14.

During one horizontal line period, the DS transistor Q3 is turned on (time t15 to t16) for each pixel 14 in the pixel row 13 to be driven, and the second correction processing is performed. For the pixel 14 for which the second correction processing has been completed, the WS transistor Q2 is turned on, and the pixel signal voltage Vsig on the data line sig is written to the gate of the driving transistor Q1 (time t18 to t19).

In the pixel 14 to which the same data line sig of the pixel row 13 different from the pixel 14 in which the WS transistor Q2 is turned on and the pixel signal voltage Vsig is written is connected, the DS transistor Q3 is turned on (time t17 to t20). In the pixel 14 in which the DS transistor Q3 is turned on, since the WS transistor Q2 is turned off, the source-gate voltage of the driving transistor Q1 can be restored to the voltage immediately before the first correction processing period without being affected by the pixel signal voltage Vsig for writing in the pixel 14 of another pixel row 13.

On the other hand, in the display device 1 according to the comparative example, as illustrated in FIG. 14B, for each pixel 14 in the corresponding pixel row 13, the WS transistor Q2 and the DS transistor Q3 are turned on to correct the threshold voltage of the driving transistor Q1 within one horizontal line period, and then the WS transistor Q2 is turned on again to write the pixel signal voltage Vsig in the gate of the driving transistor Q1 (time t1 to t6).

As a result, the display device 1 according to the present embodiment can shorten the length of one horizontal line period and draw one frame at a higher speed than the display device 1 according to the comparative example.

In FIG. 14A, when the first correction processing period ends, the DS transistor Q3 is turned on within a predetermined period (time t15 to t16) to restore the source-gate voltage of the driving transistor Q1 to the voltage immediately before the first correction processing period. However, by turning on the DS transistor Q3 a plurality of times, the source-gate voltage of the driving transistor Q1 can be restored more stably.

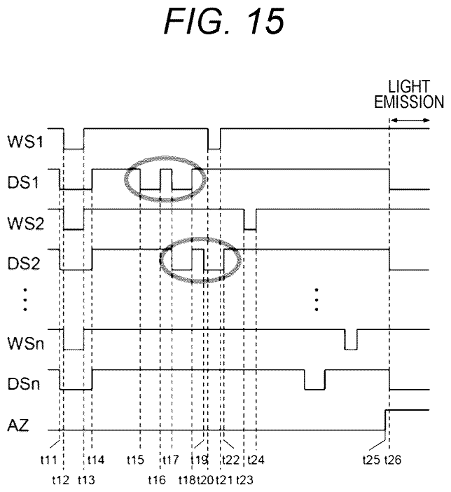

FIG. 15 is a timing diagram according to a modification of FIG. 14A. In FIG. 15, when the first correction processing period ends, the DS transistor Q3 is turned on twice (time t15 to t16, t17 to t18, t19 to t22). As a result, the voltage between the source and the gate of the driving transistor Q1 can be accurately restored by the voltage immediately before the first correction processing.

As described above, in the present embodiment, during the vertical blanking period or the like, the offset voltage Vofs is written to the gates of the driving transistors Q1 of all the pixels 14 of all the pixel rows 13, and the first correction processing is performed. Thereafter, for each pixel row 13, the DS transistor Q3 is temporarily turned on to restore the source-gate voltage of the driving transistor Q1 to a voltage immediately before the first correction processing, and then the second correction processing is performed. Subsequently, the pixel signal voltage Vsig is written to the gate of the driving transistor Q1. As a result, even if the first correction processing period is different for each pixel row 13, the threshold voltage of the driving transistor Q1 of each pixel 14 can be appropriately corrected.

Furthermore, in the present embodiment, since it is not necessary to turn on both the WS transistor Q2 and the DS transistor Q3 within one horizontal line period, one horizontal line period can be shortened.

Furthermore, in the present embodiment, while the threshold voltage of the driving transistor Q1 is corrected in one pixel row 13 of the two pixel rows 13, the pixel signal voltage Vsig can be written in the gate of the driving transistor Q1 in the other pixel row 13. Therefore, drawing for one frame can be performed at high speed.

### (Application Example of Image Display Device 1 and Electronic Device According to Present Disclosure)

### First Application Example

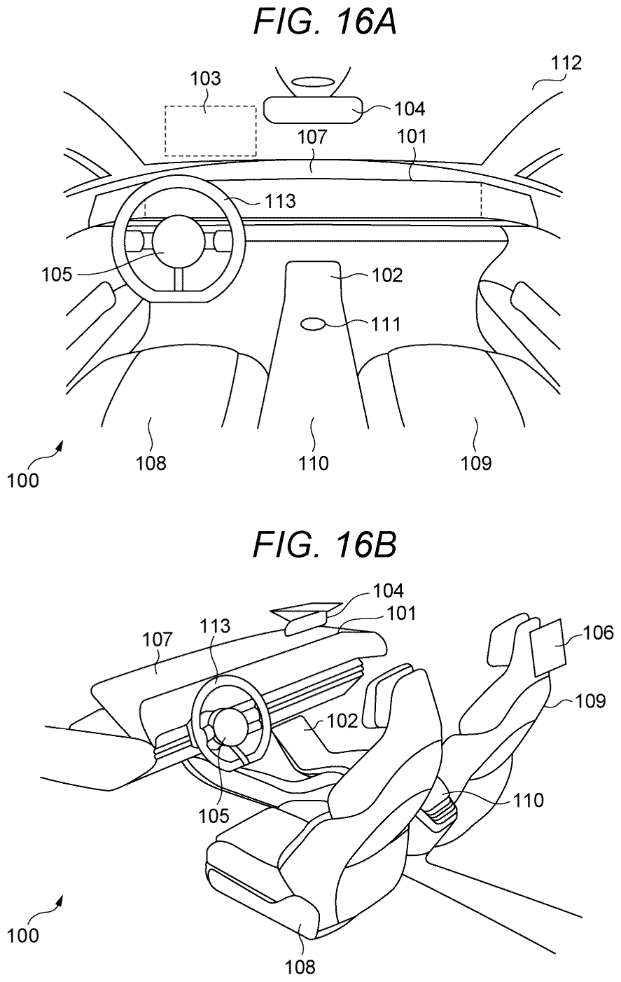

An image display device 1 and an electronic device 50 according to the present disclosure can be used for various purposes. FIGS. 16A and 16B are diagrams illustrating an internal configuration of a vehicle 100 as a first application example of the electronic device 50 including the image display device 1 according to the present disclosure. FIG. 16A is a diagram illustrating an internal state of the vehicle 100 from the rear side to the front side of the vehicle 100, and FIG. 16B is a diagram illustrating an internal state of the vehicle 100 from an oblique rear side to an oblique front side of the vehicle 100.

The vehicle 100 of FIGS. 16A and 16B includes a center display 101, a console display 102, a head-up display 103, a digital rear mirror 104, a steering wheel display 105, and a rear entertainment display 106.

The center display 101 is arranged on a dashboard 107 at a location facing a driver seat 108 and a passenger seat 109. FIG. 16 illustrates an example of the center display 101 having a horizontally long shape extending from the side of the driver seat 108 to the side of the passenger seat 109, but the screen size and arrangement location of the center display 101 are arbitrary. The center display 101 can display information detected by the various sensors. As a specific example, the center display 101 can display a captured image captured by an image sensor, an image of a distance to an obstacle in front of or on the side of the vehicle, the distance being measured by a ToF sensor, a passenger's body temperature detected by an infrared sensor, and the like. The center display 101 can be used to display, for example, at least one of safety-related information, operation-related information, a life log, health-related information, authentication/identification-related information, or entertainment-related information.

The safety-related information is information of doze sensing, looking-away sensing, sensing of mischief of a child riding together, presence or absence of wearing of a seat belt, sensing of leaving of an occupant, and the like, and is information sensed by the sensor arranged to overlap the back surface side of the center display 101, for example. The operation-related information detects a gesture related to an operation by the occupant by using the sensor. The detected gestures may include an operation of various types of equipment in the vehicle 100. For example, operations of air conditioning equipment, a navigation device, an AV device, a lighting device, and the like are detected. The life log includes life logs of all the occupants. For example, the life log includes an action record of each occupant in the vehicle. By acquiring and storing the life log, it is possible to check a state of the occupant at the time of an accident. In the health-related information, the health condition of the occupant is estimated on the basis of the body temperature of the occupant detected by using a temperature sensor. Alternatively, the face of the occupant may be imaged by using an image sensor, and the health condition of the occupant may be estimated from the imaged facial expression. Moreover, a conversation may be made with an occupant in automatic voice, and the health condition of the occupant may be estimated on the basis of the contents of a response from the occupant. The authentication/identification-related information includes a keyless entry function of performing face authentication using a sensor, and a function of automatically adjusting a seat height and position through face identification. The entertainment-related information includes a function of detecting, with a sensor, operation information about an AV device being used by an occupant, and a function of recognizing the face of the occupant with a sensor and providing content suitable for the occupant through the AV device.

The console display 102 can be used, for example, to display the life log information. The console display 102 is arranged near a shift lever 111 of a center console 110 between the driver seat 108 and the passenger seat 109. The console display 102 can also display information detected by the various sensors. Furthermore, the console display 102 may display an image of the surroundings of the vehicle captured by an image sensor, or may display an image of a distance to an obstacle present in the surroundings of the vehicle.

The head-up display 103 is virtually displayed behind a windshield 112 in front of the driver seat 108. The head-up display 103 can be used to display, for example, at least one of the safety-related information, the operation-related information, the life log, the health-related information, the authentication/identification-related information, or the entertainment-related information. Since the head-up display 103 is virtually arranged in front of the driver seat 108 in many cases, the head-up display 103 is suitable for displaying information directly related to an operation of the vehicle 100, such as a speed of the vehicle 100 and a remaining amount of fuel (battery).

The digital rear mirror 104 can not only display the rear of the vehicle 100 but can also display the state of an occupant in the rear seat, and thus can be used to display the life log information, for example, by disposing the sensor to be superimposed on the back surface side of the digital rear mirror 104.

The steering wheel display 105 is arranged near the center of a steering wheel 113 of the vehicle 100. The steering wheel display 105 can be used to display, for example, at least one of the safety-related information, the operation-related information, the life log, the health-related information, the authentication/identification-related information, or the entertainment-related information. In particular, since the steering wheel display 105 is close to the driver's hand, the steering wheel display 105 is suitable for displaying the life log information such as the body temperature of the driver, or for displaying information regarding an operation of the AV device, air conditioning equipment, or the like.

The rear entertainment display 106 is attached to the back side of the driver seat 108 and the passenger seat 109, and is for the occupant in the rear seat to view. The rear entertainment display 106 can be used to display, for example, at least one of the safety-related information, the operation-related information, the life log, the health-related information, the authentication/identification-related information, or the entertainment-related information. In particular, since the rear entertainment display 106 is in front of the occupant in the rear seat, information related to the occupant in the rear seat is displayed. For example, information regarding an operation of the AV device or the air conditioning equipment may be displayed, or a result of measurement of the body temperature or the like of an occupant in the rear seat with a temperature sensor may be displayed.

As described above, arranging the sensor on the back surface side of the image display device 1 makes it possible to measure the distance to an object existing in the surroundings. Optical distance measurement methods are roughly classified into a passive type and an active type. In the passive type method, a distance is measured by receiving light from an object without projecting light from a sensor to the object. Methods of the passive type include a lens focus method, a stereo method, and a monocular vision method. In the active type method, a distance is measured by projecting light onto an object and receiving reflected light from the object with a sensor. Methods of the active type include an optical radar method, an active stereo method, an illuminance difference stereo method, a moire topography method, and an interference method. The image display device 1 according to the present disclosure can be applied to any of these types of distance measurement.

The passive or active distance measurement described above can be performed by using the sensor disposed to overlap the back surface side of the image display device 1 according to the present disclosure.

### Second Application Example

The image display device 1 according to the present disclosure is applicable not only to various displays used in vehicles but also to displays mounted on various electronic devices 50.

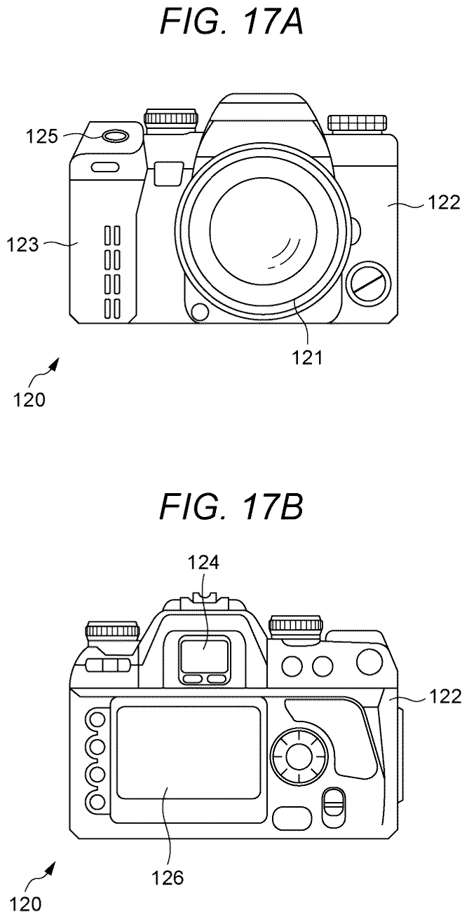

FIG. 17A is a front view of a digital camera 120 as a second application example of the electronic device 50, and FIG. 17B is a rear view of the digital camera 120. The digital camera 120 in FIGS. 17A and 17B illustrates an example of a single-lens reflex camera in which a lens 121 is replaceable, but the electronic device 50 is also applicable to a camera in which the lens 121 is not replaceable.

In the camera of FIGS. 17A and 17B, when a person who captures an image looks into an electronic viewfinder 124 to determine a composition while holding a grip 123 of a camera body 122, and presses a shutter 125 while adjusting focus, the captured image data is stored in a memory in the camera. As illustrated in FIG. 17B, on the back side of the camera, a monitor screen 126 that displays the captured image data and the like and a live image and the like, and the electronic viewfinder 124 are provided. Furthermore, there is a case where a sub screen that displays setting information such as a shutter speed and an exposure value is provided on the upper surface of the camera.

By arranging a sensor so as to overlap the back surface side of the monitor screen 126, the electronic viewfinder 124, the sub screen, and the like used for the camera, the camera can be used as the image display device 1 according to the present disclosure.

### Third Application Example

The image display device 1 according to the present disclosure is also applicable to a head mounted display (hereinafter referred to as HMD). The HMD can be used for virtual reality (VR), augmented reality (AR), mixed reality (MR), substitutional reality (SR), or the like.

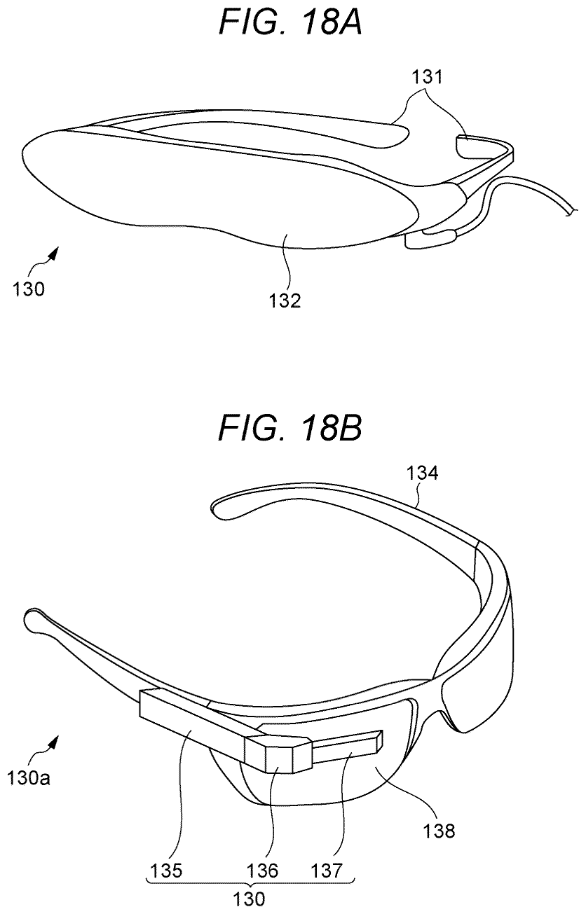

FIG. 18A is an external view of an HMD 130 as a third application example of the electronic device 50. The HMD 130 of FIG. 18A includes a mounting member 131 for attachment to cover human eyes. The mounting member 131 is, for example, hooked and fixed to human ears. A display device 132 is provided inside the HMD 130, and a wearer of the HMD 130 can visually recognize a stereoscopic image and the like with the display device 132. The HMD 130 includes, for example, a wireless communication function and an acceleration sensor, and can switch a stereoscopic image and the like displayed on the display device 132 in accordance with a posture, a gesture, and the like of the wearer.

Furthermore, a camera may be provided in the HMD 130 to capture an image around the wearer, and an image obtained by combining the image captured by the camera and an image generated by a computer may be displayed on the display device 132. For example, by arranging the camera to overlap the back surface side of the display device 132 visually recognized by the wearer of the HMD 130, capturing an image of the surroundings of the eyes of the wearer with the camera, and displaying the captured image on another display provided on the outer surface of the HMD 130, a person around the wearer can recognize the expression of the face and the movement of the eyes of the wearer in real time.

Note that various types of the HMD 130 are conceivable. For example, as illustrated in FIG. 18B, the image display device 1 according to the present disclosure is also applicable to smart glasses 130a that displays various types of information on glasses 134. The smart glasses 130a of FIG. 18B includes a main body portion 135, an arm portion 136, and a lens barrel portion 137. The main body portion 135 is connected to the arm portion 136. The main body portion 135 is detachable from the glasses 134. The main body portion 135 incorporates a display unit and a control board for controlling the operation of the smart glasses 130a. The main body portion 135 and the lens barrel portion 137 are connected to each other via the arm portion 136. The lens barrel portion 137 emits image light emitted from the main body portion 135 through the arm portion 136, toward a lens 138 of the glasses 134. This image light enters the human eyes through the lens 138. The wearer of the smart glasses 130a of FIG. 18B can visually recognize not only a surrounding situation but also various pieces of information emitted from the lens barrel portion 137 similarly to normal glasses.

### Fourth Application Example

The image display device 1 according to the present disclosure is also applicable to a television device (hereinafter referred to as TV). In recent TVs, a frame tends to be as small as possible from the viewpoint of downsizing and design properties. Therefore, in a case where a camera to capture an image of a viewer is provided on a TV, it is desirable to arrange the camera so as to overlap the back surface side of a display unit 2 of the TV.

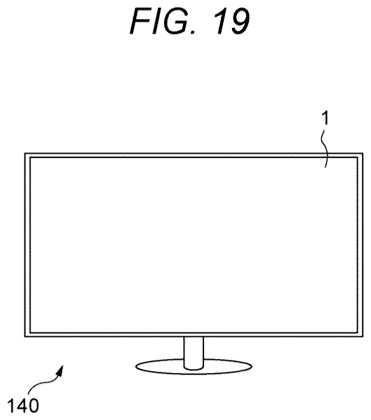

FIG. 19 is an external view of a TV 140 as a fourth application example of the electronic device 50. In the TV 140 of FIG. 19, the frame is minimized, and almost the entire region on the front side is a display area. The TV 140 may incorporate a sensor such as a camera to capture the image of the viewer.

### Fifth Application Example

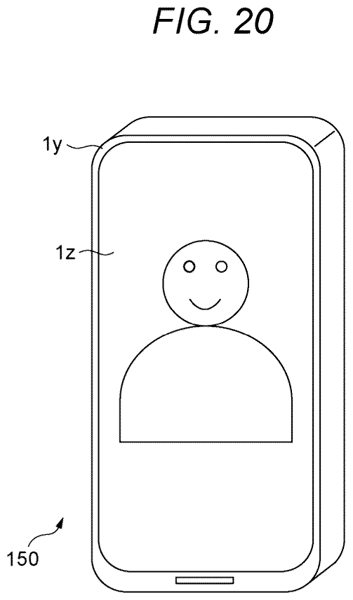

The image display device 1 according to the present disclosure is also applicable to a smartphone and a mobile phone. FIG. 20 is an external view of a smartphone 150 as a fifth application example of the electronic device 50. In an example in FIG. 20, a display surface 1z extends to nearly the outer shape of the electronic device 50, and the width of a bezel 1y around the display surface 1z is set to several millimeters or less. In general, a front camera is often mounted on the bezel 1y, but in FIG. 20, as indicated by a broken line, an image sensor module serving as the front camera is arranged on, for example, the back surface side of a substantially central portion of the display surface 1z. As described above, by providing the front camera on the back surface side of the display surface 1z in this manner, the front camera no longer need to be arranged on the bezel 1y, and thus the width of the bezel 1y can be narrowed.

Note that the present technology may have the following configurations.

(1) A display device including:
a pixel array unit in which a plurality of pixel groups each including two or more pixels arranged in a first direction is arranged in a second direction intersecting the first direction;
a light emission element provided in each pixel in the pixel array unit;
a first transistor that is provided in each pixel in the pixel array unit and controls light emission luminance of the light emission element;
a first capacitor provided in each pixel in the pixel array unit and connected between a gate and a Source of the first transistor; and
a display control unit that performs first correction processing of simultaneously correcting threshold voltages of the first transistors in a plurality of the pixel groups, then restores a source-gate voltage of the first transistor to a voltage before the start of the first correction processing, and then performs second correction processing of sequentially correcting the threshold voltage of the first transistor for each of the plurality of pixel groups, and supplies a pixel signal voltage to a gate of the first transistor for which the second correction processing has been completed.

(2) The display device according to (1), in which correction of the threshold voltage of the first transistor of each pixel is completed by the second correction processing.

(3) The display device according to (1) or (2), in which
a length of a period of the first correction processing is different for each of a plurality of the pixel groups arranged in the second direction, and
a length of a period of the second correction processing is substantially the same for the plurality of pixel groups.

(4) The display device according to any one of (1) to (3), in which
immediately before the first correction processing period, the display control unit temporarily supplies an offset voltage to gates of the first transistors in a plurality of the pixel groups to temporarily connect sources to a first reference voltage node, and
during the first correction processing period, the display control unit cuts off the supply of the offset voltage to the gates of the first transistors, and cuts off the connection between the sources of the first transistors and the first reference voltage node.

(5) The display device according to any one of (1) to (4), in which the display control unit sequentially drives each of the plurality of pixel groups to temporarily connect a source of the first transistor in the pixel group to be driven to a first reference voltage node, and thereafter, during the second correction processing period, the display control unit cuts off the connection between the source of the first transistor and the first reference voltage node and corrects a threshold voltage of the first transistor.

(6) The display device according to (5), in which the display control unit causes a source-gate voltage of the first transistor in the pixel group to be driven to match a threshold voltage of the first transistor during the second correction processing period.

(7) The display device according to any one of (1) to (6), in which after the second correction processing of the first transistors in the plurality of pixel groups is completed, the display control unit simultaneously raises source voltages of the first transistors in the plurality of pixel groups, and causes the light emission elements in the plurality of pixel groups to simultaneously emit light with luminance corresponding to the pixel signal voltage.

(8) The display device according to (7), in which the display control unit starts the first correction processing within a vertical blanking period.

(9) The display device according to any one of (1) to (6), in which the display control unit sequentially raises a source voltage of the first transistor in the pixel group to be driven for which the second correction processing has been completed, and causes the light emission element in the pixel group to be driven to emit light with luminance corresponding to the pixel signal voltage.

(10) The display device according to (9), in which the display control unit performs the first correction processing within a predetermined period.

(11) The display device according to any one of (1) to (10), in which the display control unit simultaneously performs the first correction processing on the first transistors in all the pixel groups in the pixel array unit, and then sequentially performs the second correction processing on the first transistors for each of all the pixel groups.

(12) The display device according to any one of (1) to (10), in which
the plurality of pixel groups arranged in the second direction in the pixel array unit is divided into two or more pixel blocks, and
the display control unit performs the first correction processing on the first transistor in the pixel block for each of the two or more pixel blocks, and then sequentially performs the second correction processing on the first transistor for each of the pixel groups in the pixel block.

(13) The display device according to any one of (1) to (12) further including
a second transistor that is provided in each pixel in the pixel array unit and switches whether or not to supply an offset voltage or the pixel signal voltage to a gate of the first transistor, and
a third transistor that is provided in each pixel in the pixel array unit and switches whether or not to connect a source of the first transistor to a predetermined first reference voltage node, in which
the display control unit
temporarily turns on the second transistors in a plurality of the pixel groups to temporarily supply an offset voltage to gates of the first transistors and temporarily turns on the third transistors in the plurality of pixel groups to temporarily connect sources of the first transistors to the first reference voltage node to simultaneously correct threshold voltages of the first transistors in the plurality of pixel groups arranged in the second direction during the period of the first correction processing,
thereafter sequentially drives each of the plurality of pixel groups to temporarily turn on the third transistor in the pixel group to be driven and temporarily connect the source of the first transistor to the first reference voltage node,
during the period of the second correction processing, cuts off the connection between the source of the first transistor and the first reference voltage node to correct the threshold voltage of the first transistor, and
thereafter, temporarily turns on the second transistor connected to the gate of the first transistor whose threshold voltage has been corrected, and supplies the pixel signal voltage to the gate of the first transistor whose threshold voltage has been corrected.

(14) The display device according to (13), in which immediately before the second correction processing period, the display control unit repeats an operation of temporarily turning on the third transistor in the pixel group to be driven a plurality of times, and thereafter, turns off the second transistor and the third transistor to correct the threshold voltage of the first transistor.

(15) The display device according to (13) or (14) further including
a fourth transistor that switches whether or not to connect a drain of the first transistor to a second reference voltage node, and
a second capacitor connected between a source of the first transistor and a source of the third transistor, in which
the light emission element is connected between a drain of the first transistor and the second reference voltage node.

(16) The display device according to (15), in which
before the second transistor transitions from off to on in a state where the pixel signal voltage is supplied to a source of the second transistor, the fourth transistor maintains an on state, and a drain of the first transistor is connected to the second reference voltage node, and
when the second transistor transitions from off to on in a state where the pixel signal voltage is supplied to the source of the second transistor, the fourth transistor is turned off, and then the third transistor is turned on, and light emission of the light emission element is started.

(17) The display device according to (15) or (16), in which the first transistor, the second transistor, the third transistor, and the fourth transistor include P-type metal oxide semiconductor (MOS) transistors.

(18) The display device according to any one of (1) to (17), in which while the threshold voltage of the first transistor is corrected in one of the two pixel groups in the second direction, the display control unit supplies the pixel signal voltage to a gate of the first transistor in the other of the two pixel groups.

(19) The display device according to any one of (1) to (18), in which the light emission element includes an organic electro-luminescence (EL) element.

(20) A driving method of a display device including:
a pixel array unit in which a plurality of pixel groups each including two or more pixels arranged in a first direction is arranged in a second direction intersecting the first direction;
a light emission element provided in each pixel in the pixel array unit;
a first transistor that is provided in each pixel in the pixel array unit and controls light emission luminance of the light emission element; and
a first capacitor provided in each pixel in the pixel array unit and connected between a gate and a source of the first transistor, the method including
performing first correction processing of simultaneously correcting threshold voltages of the first transistors in a plurality of the pixel groups, then restoring a source-gate voltage of the first transistor to a voltage before the start of the first correction processing, and then performing second correction processing of sequentially correcting the threshold voltage of the first transistor for each of the plurality of pixel groups, and supplying a pixel signal voltage to a gate of the first transistor for which the second correction processing has been completed.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

1 Display device
1y Bezel
1z Display surface
2 Display unit
3 Display control unit
4 Timing control unit
5 Data input/output I/F unit
6 Pixel array unit
7 Write scanning unit
8 Light emission drive unit
9 Auto zero scanning unit
10 Signal output unit
11 Scan control unit
12 Write control unit
13 Pixel row
13 All pixel rows
14 Pixel
21 Clock generation unit
22 Timing generation unit
23 Image processing unit
24 High-speed I/F unit
25 S/P conversion unit
26 Clock control unit
27 H/V synchronization generation unit
50 Electronic device
100 Vehicle
101 Center display
102 Console display
103 Head-up display
104 Digital rear mirror
105 Steering wheel display
106 Rear entertainment display
107 Dashboard
108 Driver seat
109 Passenger seat
110 Center console
111 Shift lever
112 Windshield
113 Steering wheel
120 Digital camera
121 Lens
122 Camera body
123 Grip
124 Electronic viewfinder
125 Shutter
126 Monitor screen
130a Smart glasses
131 Mounting member
132 Display device
134 Glasses
135 Main body portion
136 Arm portion
137 Lens barrel portion
138 Lens
150 Smartphone

1. A display device comprising:
a pixel array unit in which a plurality of pixel groups each including two or more pixels arranged in a first direction is arranged in a second direction intersecting the first direction;
a light emission element provided in each pixel in the pixel array unit;
a first transistor that is provided in each pixel in the pixel array unit and controls light emission luminance of the light emission element;
a first capacitor provided in each pixel in the pixel array unit and connected between a gate and a Source of the first transistor; and
a display control unit that performs first correction processing of simultaneously correcting threshold voltages of the first transistors in a plurality of the pixel groups, then restores a source-gate voltage of the first transistor to a voltage before the start of the first correction processing, and then performs second correction processing of sequentially correcting the threshold voltage of the first transistor for each of the plurality of pixel groups, and supplies a pixel signal voltage to a gate of the first transistor for which the second correction processing has been completed.

2. The display device according to claim 1, wherein correction of the threshold voltage of the first transistor of each pixel is completed by the second correction processing.

3. The display device according to claim 1, wherein
a length of a period of the first correction processing is different for each of a plurality of the pixel groups arranged in the second direction, and
a length of a period of the second correction processing is substantially the same for the plurality of pixel groups.

4. The display device according to claim 1, wherein immediately before the first correction processing period, the display control unit temporarily supplies an offset voltage to gates of the first transistors in a plurality of the pixel groups to temporarily connect sources to a first reference voltage node, and
during the first correction processing period, the display control unit cuts off the supply of the offset voltage to the gates of the first transistors, and cuts off the connection between the sources of the first transistors and the first reference voltage node.

5. The display device according to claim 1, wherein the display control unit sequentially drives each of the plurality of pixel groups to temporarily connect a source of the first transistor in the pixel group to be driven to a first reference voltage node, and thereafter, during the second correction processing period, the display control unit cuts off the connection between the source of the first transistor and the first reference voltage node and corrects a threshold voltage of the first transistor.

6. The display device according to claim 5, wherein the display control unit causes a source-gate voltage of the first transistor in the pixel group to be driven to match a threshold voltage of the first transistor during the second correction processing period.

7. The display device according to claim 1, wherein after the second correction processing of the first transistors in the plurality of pixel groups is completed, the display control unit simultaneously raises source voltages of the first transistors in the plurality of pixel groups, and causes the light emission elements in the plurality of pixel groups to simultaneously emit light with luminance corresponding to the pixel signal voltage.

8. The display device according to claim 7, wherein the display control unit starts the first correction processing within a vertical blanking period.

9. The display device according to claim 1, wherein the display control unit sequentially raises a source voltage of the first transistor in the pixel group to be driven for which the second correction processing has been completed, and causes the light emission element in the pixel group to be driven to emit light with luminance corresponding to the pixel signal voltage.

10. The display device according to claim 9, wherein the display control unit performs the first correction processing within a predetermined period.

11. The display device according to claim 1, wherein the display control unit simultaneously performs the first correction processing on the first transistors in all the pixel groups in the pixel array unit, and then sequentially performs the second correction processing on the first transistors for each of all the pixel groups.

12. The display device according to claim 1, wherein
the plurality of pixel groups arranged in the second direction in the pixel array unit is divided into two or more pixel blocks, and
the display control unit performs the first correction processing on the first transistor in the pixel block for each of the two or more pixel blocks, and then sequentially performs the second correction processing on the first transistor for each of the pixel groups in the pixel block.

13. The display device according to claim 1 further comprising:
a second transistor that is provided in each pixel in the pixel array unit and switches whether or not to supply an offset voltage or the pixel signal voltage to a gate of the first transistor; and
a third transistor that is provided in each pixel in the pixel array unit and switches whether or not to connect a source of the first transistor to a predetermined first reference voltage node, wherein
the display control unit
temporarily turns on the second transistors in a plurality of the pixel groups to temporarily supply an offset voltage to gates of the first transistors and temporarily turns on the third transistors in the plurality of pixel groups to temporarily connect sources of the first transistors to the first reference voltage node to simultaneously correct threshold voltages of the first transistors in the plurality of pixel groups arranged in the second direction during the period of the first correction processing,
thereafter sequentially drives each of the plurality of pixel groups to temporarily turn on the third transistor in the pixel group to be driven and temporarily connect the source of the first transistor to the first reference voltage node,
during the period of the second correction processing, cuts off the connection between the source of the first transistor and the first reference voltage node to correct the threshold voltage of the first transistor, and
thereafter, temporarily turns on the second transistor connected to the gate of the first transistor whose threshold voltage has been corrected, and supplies the pixel signal voltage to the gate of the first transistor whose threshold voltage has been corrected.

14. The display device according to claim 13, wherein immediately before the second correction processing period, the display control unit repeats an operation of temporarily turning on the third transistor in the pixel group to be driven a plurality of times, and thereafter, turns off the third transistor to correct the threshold voltage of the first transistor.

15. The display device according to claim 13 further comprising:
a fourth transistor that switches whether or not to connect a drain of the first transistor to a second reference voltage node; and
a second capacitor connected between a source of the first transistor and a source of the third transistor, wherein
the light emission element is connected between a drain of the first transistor and the second reference voltage node.

16. The display device according to claim 15, wherein
before the second transistor transitions from off to on in a state where the pixel signal voltage is supplied to a source of the second transistor, the fourth transistor maintains an on state, and a drain of the first transistor is connected to the second reference voltage node, and
when the second transistor transitions from off to on in a state where the pixel signal voltage is supplied to the source of the second transistor, the fourth transistor is turned off, and then the third transistor is turned on, and light emission of the light emission element is started.

17. The display device according to claim 15, wherein the first transistor, the second transistor, the third transistor, and the fourth transistor include P-type metal oxide semiconductor (MOS) transistors.

18. The display device according to claim 1, wherein while the threshold voltage of the first transistor is corrected in one of the two pixel groups in the second direction, the display control unit supplies the pixel signal voltage to a gate of the first transistor in the another of the two pixel groups.

19. The display device according to claim 1, wherein the light emission element includes an organic electro-luminescence (EL) element.

20. A driving method of a display device including:
a pixel array unit in which a plurality of pixel groups each including two or more pixels arranged in a first direction is arranged in a second direction intersecting the first direction;
a light emission element provided in each pixel in the pixel array unit;
a first transistor that is provided in each pixel in the pixel array unit and controls light emission luminance of the light emission element; and
a first capacitor provided in each pixel in the pixel array unit and connected between a gate and a source of the first transistor, the method comprising
performing first correction processing of simultaneously correcting threshold voltages of the first transistors in a plurality of the pixel groups, then restoring a source-gate voltage of the first transistor to a voltage before the start of the first correction processing, and then performing second correction processing of sequentially correcting the threshold voltage of the first transistor for each of the plurality of pixel groups, and supplying a pixel signal voltage to a gate of the first transistor for which the second correction processing has been completed.
